(19) United States
(12) Patent Application Publication
(10) Pub. No.: US 2026/0041115 A1
(43) Pub. Date: Feb. 12, 2026

(54) Frozen Coffee Custard Hybrid Product

(71) Applicant: Joseph Maxim, Cleveland, TN (US)

(72) Inventor: Joseph Maxim, Cleveland, TN (US)

(21) Appl. No.: 19/294,731

(22) Filed: Aug. 8, 2025

Related U.S. Application Data
(60) Provisional application No. 63/681,095, filed on Aug. 8, 2024.

(51) Int. Cl. A23G 9/40

(52) U.S. Cl. CPC A23G 9/40; A23G 2200/00

(57) ABSTRACT

A frozen coffee custard hybrid product is disclosed, along with several formulations and manufacturing methods. A single product serving has a caffeine content equivalent to a serving of coffee, and formulations are provided using various dairy, fiber, and sweetener sources that are combined to create a creamy and smooth texture similar to premium ice cream. As a frozen product, consumers can enjoy their daily serving of coffee by simply opening the freezer. Additionally, the formulations utilize natural sweeteners to mitigate the adverse health effects of consuming processed sugars and fiber to improve digestive and heart health. The preferred embodiment discloses a frozen coffee custard hybrid product comprising whole milk in an amount in the range of 25 to 75 wt. %, heavy cream in an amount in the range of 5 to 20 wt. %, skim powder in an amount in the range of 0.5 to 5 wt. %, an emulsifier in an amount in the range of 1 to 20 wt. %, sweetener in an amount in the range of 10 to 30 wt. %, and coffee in an amount in the range of 0.8 to 5 wt. %.

### CROSS-REFERENCE TO RELATED APPLICATIONS

This application claims priority from U.S. Provisional Patent Application No. 63/681,095 filed on Aug. 8, 2024. The entire disclosure of the prior application is considered to be part of the disclosure of the accompanying application and is hereby incorporated by reference.

### BACKGROUND OF THE INVENTION

### 1. Field of the Invention

The invention is generally directed to a frozen coffee custard hybrid product. In particular, the invention discloses a sugar-free and keto-friendly frozen coffee custard hybrid product containing amounts of caffeine comparable to those found in a serving of coffee. As a frozen product, it is available for immediate consumption without the need to prepare a serving of coffee or hire a barista at a coffee specialty shop.

### 2. Description of the Related Art

Coffee was introduced to North America in 1723 by the Dutch East Indies Company, which brought it to the British colonists. For the past 300 years, Americans of all walks of life have enjoyed coffee primarily as a hot beverage for consumption in the morning, as the relatively high levels of caffeine within a serving of coffee act as a stimulant to quickly increase alertness after waking up. Coffee is also commonly consumed during the day, particularly after lunch, to boost alertness. In the 1920s, iced coffee was popularized, and espresso forms of coffee became common in the 1980s. As these forms of coffee require more expensive equipment or more time and effort to create, businesses tailored for serving these forms of coffee, along with traditional hot coffee, grew extensively during the 1980s to satisfy demand and became known as coffee shops or coffee cafes.

Presently, time demands on Americans have made it increasingly more challenging to visit a coffee shop to order a serving of coffee. While most businesses offer free coffee to their employees, they often prefer to drink a serving of coffee from a coffee shop because the coffee experience is enhanced when combined with a dairy product, such as cream. It would be advantageous to offer a form of coffee containing cream that employees, as well as busy students and family members, can easily take with them for consumption without having to visit a coffee shop.

Such a product would require certain qualities to be successful. One quality is that the product must have caffeine levels comparable to those of a standard coffee serving. An important quality is that the product should be creamy and smooth like a serving of coffee containing cream. Another quality is that the product should be storable for long periods, allowing it to be easily taken and consumed when caffeine is needed. Yet another quality is to use a natural sweetener, such as Stevia or monk fruit, to avoid the high levels of sugar, corn syrup, and fructose found in coffee beverages. Sugar, corn syrup, and fructose are significant factors in the development of obesity and diabetes.

U.S. patent publication 2005/0095336 to Pete Maletto discloses a low-carbohydrate ice cream formulation that is rich in fiber. The disclosed ice cream base formulation is free of milk and, hence, lactose and is comprised of heavy cream, water, maltodextrin soluble fiber, polydextrose, whey protein concentrate, glycerin, egg yolks, lecithin, xanthan gum, microcellulose gum, a mixture of locust bean gum and carrageenan gum, a mixture of mono- and diglycerides of short chain fatty acids and an artificial sweetener that is a combination of acesulfame potassium and sucralose. The disclosed ice cream is prepared by blending a suitable flavor into the subject base formulations and is comparable to conventional premium ice cream.

U.S. Pat. No. 4,855,156 to Norma Singer et. al. discloses a non-fat and reduced-fat whipped frozen dessert product wherein part or all of the milk fat, vegetable fat, or oil ordinarily incorporated therein is replaced by a proteinaceous macrocolloid of, e.g., denatured whey protein particles. The illustrative embodiments include non-fat ice cream analog products with reduced calorie content, enhanced nutritional value due to increased protein content, while claiming physical and organoleptic characteristics of full-fat ice creams.

U.S. patent publication 2005/0281932 to Ramin Ghaffari et. al. discloses a frozen confection containing one or more plant sterols and/or stanols and/or one or more esters thereof. The disclosed confection includes milk solids and modest amounts of milk fat, providing a low-fat frozen confection, such as low-fat ice cream, which offers the consumer valuable plant sterols or stanols, or their esters, while claiming good taste and mouthfeel.

While there have been numerous disclosures of formulations for an ice cream-like product with lower levels of sugar, corn syrup, and fructose, none incorporate the energy-inducing effects of caffeine as part of the composition. The proper formulation of a frozen coffee custard hybrid product that uses a natural sweetener to replace traditional use of sugar, corn syrup, and fructose as sweeteners, incorporates high fiber ingredients such as flax seeds, ground chickpeas, lentils, chia seeds, or oats, with levels of caffeine comparable to that of a serving of coffee would serve the needs of many. Those who want a quick caffeine energy boost without having to make a trip to a coffee cafe would greatly desire the embodiments disclosed herein.

### BRIEF SUMMARY OF THE INVENTION

The present invention is directed to the discovery of combinations of ingredients for various frozen coffee custard hybrid products, which enable the formulator to maintain outstanding organoleptic properties while using natural sweeteners, high-fiber ingredients, and amounts of caffeine comparable to those of a serving of coffee. The disclosed frozen coffee custard hybrid products would benefit individuals who lack time to visit a coffee cafe and desire to consume their coffee in a creamy base, increase their fiber intake, and decrease their caloric intake.

In particular, the present invention is further captured by any one or any combination of one or more of the below numbered specific aspects:

A frozen coffee custard hybrid product comprising whole milk in an amount in the range of 25 to 75 wt. %, heavy cream in an amount in the range of 5 to 20 wt. %, skim powder in an amount in the range of 0.5 to 5 wt. %, an emulsifier in an amount in the range of 1 to 20 wt. %, sweetener in an amount in the range of 10 to 30 wt. %, and coffee in an amount in the range of 0.8 to 5 wt. %.

A frozen decaffeinated coffee custard hybrid product comprising a dairy source in an amount in the range of 25 to 75 wt. %, heavy cream in an amount in the range of 5 to 20 wt. %, skim powder in an amount in the range of 0.5 to 5 wt. %, an emulsifier in an amount in the range of 1 to 20 wt. %, sweetener in an amount in the range of 10 to 30 wt. %, and decaffeinated coffee in an amount in the range of 0.8 to 5 wt. %.

A caramel flavored frozen coffee custard hybrid product comprising a dairy source in an amount in the range of 25 to 75 wt. %, heavy cream in an amount in the range of 5 to 20 wt. %, skim powder in an amount in the range of 0.5 to 5 wt. %, an emulsifier in an amount in the range of 1 to 20 wt. %, sweetener in an amount in the range of 10 to 30 wt. %, coffee in an amount in the range of 0.8 to 5 wt. %, caramel flavor in an amount in the range of 10 to 20 wt. %, and Cinnamon in an amount in the range of 0.2 to 1.0 wt. %.

An almond flavored frozen coffee custard hybrid product comprising whole milk in an amount in the range of 25 to 75 wt. %, heavy cream in an amount in the range of 5 to 20 wt. %, skim powder in an amount in the range of 0.5 to 5 wt. %, egg yoke in an amount in the range of 1 to 20 wt. %, LOSWEET® in an amount in the range of 10 to 30 wt. %, coffee in an amount in the range of 0.8 to 5 wt. %, and almond extract in an amount in the range of 0.05 to 0.20 wt. %.

For a more complete understanding of the above and other features and advantages of the invention, reference should be made to the following description of the preferred and secondary embodiments.

### Definitions

The word “cream” is any one or any combination of: a dairy cream, wherein the dairy cream is any one or any combination of: heavy cream, half-and-half cream, light cream, whipping cream, light cream, and skim milk cream; a non-dairy cream, wherein the non-dairy cream is any one or any combination of: oat milk cream, soy milk cream, cashew milk cream, silken tofu cream, coconut milk cream, almond milk cream, and creamers made from a combination of ingredients like coconut oil, palm oil, corn syrup solids, and stabilizers.

The word “emulsifier” is any one or any combination of: a plant-based source, wherein the plant-based source is any one or any combination of: xanthan gum, guar gum, locust bean gum, gum arabic, carrageenan, Agar-agar, and soybeans; an animal-based source, wherein the animal-based source is any one or any combination of: milk, egg yolks, and eggs.

The word “fiber” is any one or any combination of: flax seeds, chickpeas, lentils, chia seeds, oats, pumpkin or sweet potato puree, or other similar products.

The word “milk” is any one or any combination of: a dairy milk, wherein the dairy milk is any one or any combination of: whole milk, reduced-fat milk, low-fat milk, and skim milk; a non-dairy milk, wherein the non-dairy milk is any one or any combination of: oat milk, soy milk, cashew milk, silken tofu milk, coconut milk, and almond milk.

The word “sweetener” is any one or any combination of: stevia, LOSWEET®, and monk fruit.

### DETAILED DESCRIPTION OF THE INVENTION

The following description of the preferred embodiment(s) is merely exemplary in nature and is in no way intended to limit the invention, its application, or uses. In accordance with the present disclosure, frozen coffee custard hybrid base formulations are provided that use natural sweeteners, are high in fiber, and set in a creamy dairy base that is in all respects comparable to conventional premium ice cream, where each serving contains levels of caffeine similar to that of a serving of coffee. Most importantly, the formulation of the invention is comparable to conventional ice cream in taste, texture, and mouth feel, but provides a boost of caffeine-driven energy. The subject formations are a unique blend of ingredients designed to yield the advantageous properties that render it comparable to conventional ice cream without the high levels of sugar, corn syrup, or fructose. The ingredients of the subject formulations are as follows.

It will be demonstrated that the primary ingredient of the disclosed frozen coffee custard hybrid product is a dairy source, such as milk. The milk may take many forms. For an optimal experience in taste and texture, the milk will be in the form of whole milk. However, other forms of milk, such as skim milk, condensed milk, evaporated milk, cream, butter, butterfat, whey, and non-fat milk solids, may also be used. This list is exemplary and not meant to be limiting. The examples below show the wt % and preferred range when whole milk is used. When other forms of milk are used, the values for wt % and the preferred range may change. The dairy source will generally contribute dairy fat and/or non-fat milk solids such as lactose and milk proteins, e.g. whey proteins and caseins.

A primary secondary ingredient of the disclosed frozen coffee custard hybrid product is a source of cream, such as heavy cream. The cream may take many forms. For an optimal experience in taste and texture, the cream will be in the form of heavy cream. The fat content of heavy cream, also known as heavy whipping cream, is a key characteristic that distinguishes it from other types of cream. In the United States, it is legally defined as having a milkfat content of at least 36%. However, other forms of cream, such as half-and-half, light cream, whipping cream, or double cream, may also be used. This list is exemplary and not meant to be limiting. The examples below show the wt % and preferred range when heavy cream is used. When other forms of cream, such as non-fat or plant-based cream, are used, the values for wt % and the preferred range may change. Plant-based creams include, but are not limited to, oat milk cream, soy milk cream, cashew milk cream, silken tofu cream, coconut milk cream, almond milk cream, and creamers made from a combination of ingredients like coconut oil, palm oil, corn syrup solids, and stabilizers. The fat molecules in the cream source will generally contribute to the silky, smooth, and decadent mouthfeel of the frozen coffee custard hybrid product. The fat molecules in the cream source also help thicken the custard, preventing the egg proteins from bonding too tightly and becoming rubbery or curdled.

Another primary secondary ingredient of the disclosed frozen coffee custard hybrid product is a source of sweetener. For a healthy experience, natural sweeteners should be used. Natural sweeteners generally refer to sweeteners derived from natural sources and often undergo less processing than refined white sugar or artificial sweeteners, such as aspartame, sucralose, saccharin, and others. Refined and artificial sweeteners should be avoided because they can cause weight gain and obesity, insulin resistance and type 2 diabetes, heart disease, and more. Natural sweeteners derived from the leaves of the Stevia rebaudiana plant or from Monk Fruit, a fruit native to Southeast Asia, are far sweeter than sugar yet without the high calorie content. STEVIA IN THE RAW® is a common brand name sweetener based on the Stevia rebaudiana plant. LOSWEET® is a common brand name sweetener derived from Monk Fruit.

Another essential ingredient of the disclosed frozen coffee custard hybrid product is the coffee itself. The main active ingredient of coffee, caffeine, stimulates the central nervous system by blocking the adenosine receptors. Adenosine buildup in the brain reduces an individual's alertness. Caffeine blocks the reception of adenosine, thereby increasing alertness. Caffeine also indirectly increases the release of other neurotransmitters, such as dopamine and norepinephrine, that are associated with alertness, focus, and a feeling of energy. The amount of caffeine in a serving of coffee varies significantly depending on several factors, including the type of coffee bean, brewing method, and serving size. The frozen coffee custard hybrid product is intended to replace a typical 8-ounce serving of coffee, which contains somewhere between 95 and 165 mg of caffeine.

Skim powder is another essential ingredient of the disclosed frozen coffee custard hybrid product. The proteins in skim powder help to create a thicker and more stable custard by acting as a stabilizer, binding with the liquid to contribute to a smoother texture. By using skim powder appropriately, the frozen coffee custard hybrid product can achieve a silky texture without the extra fat that is present when using heavy cream exclusively. As a result, the frozen coffee custard hybrid product is lower in fat, enabling consumers to manage their weight better and improve their heart and digestive health. The examples below demonstrate the preferred content and range of skim powder that will produce a creamy and smooth product while being low in fat.

A final key ingredient of the disclosed frozen coffee custard hybrid product is an emulsifier source such as egg yolks. The emulsifier may be synthetic or natural. Common synthetic emulsifiers include mono- and diglycerides, as well as polysorbates. Natural emulsifiers include various plant-based sources such as xanthan gum, guar gum, locust bean gum, gum arabic, carrageenan, agar-agar, and soybeans as well as animal-based sources such as milk and eggs. The purpose of an emulsifier in custard is to create a stable, smooth, and uniform mixture of ingredients that would naturally separate, particularly fat and water. The primary natural emulsifier in custards is lecithin, which is a type of fat found in high concentrations in egg yolks. The use of egg yolks is essential not only for thickening the custard through protein coagulation but also for its powerful emulsifying properties.

One method of creating the disclosed frozen coffee custard hybrid product comprises the following steps. The first step is to place the dairy, cream, emulsifier, skim powder, sweetener, and coffee source materials into a container. The second step is to stir the source materials thoroughly for several minutes, preferably 30 minutes, to form a mix. The third step is to process the mix through a homogenizer to create a stable, uniform, and consistent mixture of all the ingredients. The fourth step is then to process the mix through a pasteurizer at a set temperature and for a set period of time to kill any harmful microorganisms that may be present in the mix. The pasteurization process ensures food safety, extends the shelf life, and preserves quality. The fifth step is then to cool the mix to a temperature of 40 degrees F. The sixth step is then to process the mix through a continuous freezer. A continuous freezer is one of two types of freezers used in the industry to harden a liquid product so that it can be easily packaged; the other is a batch freezer. Batch freezers are typically found in an artisanal ice cream shop. Batch freezers produce a fixed quantity of product per cycle, which is then manually emptied before a new batch can be made. Continuous freezers provide an automated system where the product mix is continuously pumped into one end, frozen, and then aerated before exiting the other end, ready for packaging. The seventh step, once the product exits the continuous freezer, is then to divide the mix into individual servings, each serving comprising a stick for handling. The eighth step is to package the individual servings and place them into a flash freezer to be hardened for shipment. Flash freezers, also known as blast or shock freezers, are a type of freezer designed to freeze products extremely quickly.

Another method of creating the disclosed frozen coffee custard hybrid product comprises the following steps. The first step is to combine the coffee and dairy sources. The second step is to whisk the egg yolks while heating to a range between 170 and 180 degrees F. The eggs will thicken and turn light yellow. Hold the temperature for 10 minutes. The third step will be to stir the eggs, as processed in the second step, with the combined coffee and dairy from the first step, along with cream, LOSWEET®, and vanilla to create a mix. The fourth step is to cool the mix down to 40 degrees F. and maintain the temperature for four hours. The fifth step is to precool a tabletop ice cream machine. The sixth step is to stir the mix in the tabletop ice cream machine for 20 to 30 minutes, until the mix forms a soft, ice cream-like consistency. The seventh step is to remove the hardened mix from the tabletop ice cream machine, divide the mix into individual servings, and insert a stick into each serving. The eighth step is to store the individual servings in a freezer with a temperature set in the range of minus 5 to minus 15 degrees F.

The frozen coffee custard hybrid product prepared from the formulations of the present disclosure is comparable in consistency, taste, and mouthfeel to conventional premium ice cream, but with the added benefit of providing a caffeine-boosting energy effect from the included coffee ingredient. The caffeine energy-boosting effect of one serving of the formulation is similar to that of a serving of coffee. The disclosed frozen coffee custard hybrid formulations are advantageous to individuals on a low-sugar diet. The subject formulations offer a healthy alternative to traditional premium ice creams, without compromising on taste or satisfaction.

The following examples further illustrate the current invention, but are not in any way intended as being limiting thereon:

### Example 1

Example 1 is a formulation for a frozen coffee custard hybrid product having caffeine levels comparable to a serving of coffee. This formulation, identified as the Cafe formula, can be consumed as a frozen custard, converted into a hot latte by adding water and microwaved, or blended with ice to create a smoothie. This provides the consumer with flexibility on how to consume the Cafe formula and to customize the flavoring with ingredients such as orange extract, anisette, liqueur, or even maraschino cherries.

| | Preferred Amount | Preferred Range |
|---|---|---|
| Ingredient | wt. % | wt. % |
| Milk | 49.7 | 25-75 |
| Cream | 20.3 | 5-25 |
| Skim Powder | 2.0 | 0.5-5 |
| Emulsifier | 6.3 | 1-20 |
| Sweetner | 20.3 | 10-30 |
| Coffee | 1.4 | 0.8-5 |

### Example 2

Example 2 is a formulation for a frozen coffee custard hybrid product similar to Example 1 but with decaffeinated coffee. This formulation, known as the Decaf formula, is designed for individuals who wish to avoid caffeine or enjoy the taste of coffee later in the day. This formulation, just as in Example 1, can be consumed as a frozen custard, converted into a hot latte by adding water and microwaving, or blended with ice to create a smoothie. This provides the consumer with flexibility on how to consume this formula and to customize the flavoring with ingredients such as orange extract, anisette, liqueur, or even maraschino cherries.

| | Preferred Amount | Preferred Range |
|---|---|---|
| Ingredient | wt. % | wt. % |
| Milk | 49.7 | 25-75 |
| Cream | 20.3 | 5-25 |
| Skim Powder | 2.0 | 0.5-5 |
| Emulsifier | 6.3 | 1-20 |
| Sweetner | 20.3 | 10-30 |
| Decaf Coffee | 1.4 | 0.8-5 |

### Example 3

Example 3 is a formulation for a frozen coffee custard hybrid product similar to Example 1 but with caramel and cinnamon flavoring. This formulation, known as the Caramel formula, can be consumed as a frozen custard, converted into a hot latte by adding water and microwaving, or blended with ice to create a smoothie. This provides the consumer with flexibility on how to consume this formula and to customize the flavoring with ingredients such as orange extract, anisette, liqueur, or even maraschino cherries.

| | Preferred Amount | Preferred Range |
|---|---|---|
| Ingredient | wt. % | wt. % |
| Milk | 42.74 | 25-75 |
| Cream | 17.44 | 5-20 |
| Skim Powder | 1.68 | 0.5-5 |
| Emulsifier | 5.42 | 1-20 |
| Sweetner | 17.46 | 10-30 |
| Coffee | 1.25 | 0.8-5 |
| Caramel | 13.97 | 10-20 |
| Cinammon | 0.04 | 0.2-1.0 |

### Example 4

Example 4 is a formulation for a frozen coffee custard hybrid product similar to Example 1 but with pumpkin flavoring. This formulation, known as the Pumpkin Spice formula, can be consumed as a frozen custard, converted into a hot latte by adding water and microwaving, or blended with ice to create a smoothie. This provides the consumer with flexibility on how to consume this formula and to customize the flavoring with ingredients such as orange extract, anisette, liqueur, or even maraschino cherries.

| | Preferred Amount | Preferred Range |
|---|---|---|
| Ingredient | wt. % | wt. % |
| Milk | 48.35 | 25-75 |
| Cream | 19.73 | 5-20 |
| Skim Powder | 1.90 | 0.5-5 |
| Emulsifier | 6.14 | 1-20 |
| Sweetner | 19.75 | 10-30 |
| Coffee | 1.41 | 0.8-5 |
| Pumpkin Puree | 2.63 | 5-20 |
| Pumpkin Spice | 0.04 | 0.2-1.0 |

### Example 5

Example 5 is a formulation for a frozen coffee custard hybrid product similar to Example 1 but with cocoa flavoring. This formulation, known as the Dark Chocolate Moka formula, can be consumed as a frozen custard, converted into a hot latte by adding water and microwaving, or blended with ice to create a smoothie. This provides the consumer with flexibility on how to consume this formula and to customize the flavoring with ingredients such as orange extract, anisette, liqueur, or even maraschino cherries.

| | Preferred Amount | Preferred Range |
|---|---|---|
| Ingredient | wt. % | wt. % |
| Milk | 49.5 | 25-75 |
| Cream | 20.2 | 5-25 |
| Skim Powder | 1.9 | 0.5-5 |
| Emulsifier | 6.3 | 1-20 |
| Sweetner | 20.2 | 10-30 |
| Coffee | 1.5 | 0.8-5 |
| Cocoa | 0.4 | 0.2-1.0 |

### Example 6

Example 6 is a formulation for a frozen coffee custard hybrid product similar to Example 1 but with almond flavoring. This formulation, known as the Almond formula, can be consumed as a frozen custard, converted into a hot latte by adding water and microwaving, or blended with ice to create a smoothie. This provides the consumer with flexibility on how to consume this formula and to customize the flavoring with ingredients such as orange extract, anisette, liqueur, or even maraschino cherries.

| | Preferred Amount | Preferred Range |
|---|---|---|
| Ingredient | wt. % | wt. % |
| Milk | 49.7 | 25-75 |
| Cream | 20.3 | 5-20 |
| Skim Powder | 1.9 | 0.5-5 |
| Emulsifier | 6.3 | 1-20 |
| Sweetner | 20.3 | 10-30 |
| Coffee | 1.4 | 0.8-5 |
| Almond Extract | 0.1 | 0.05-0.20 |

The following three examples disclose a frozen coffee and low-fat or low-milk hybrid product. The examples include espresso, macchiato, and cappuccino, embodiments of the frozen coffee and low-fat or low-milk hybrid product. These embodiments must be made in a fudge sickle-type formulation. The ingredients may include espresso coffee, gelatin, starch, Guar gum, water, and small amounts of milk or cream. These would be made for those enjoying frozen coffee with a lower dairy content.

### Example 7

Example 7 is a formulation for a frozen coffee custard hybrid product, which is fortified with fiber and protein. This formulation, known as the Keto formula, is fortified with fiber and protein, unlike regular coffee beverages. The protein can be either animal- or plant-based. The fiber is plant-based. The Keto formula is a healthier product, as it is sugar-free and low in carbohydrates.

| | Preferred Amount | Preferred Range |
|---|---|---|
| Ingredient | wt. % | wt. % |
| Milk | 45.3 | 25-75 |
| Cream | 18.5 | 5-20 |
| Skim Powder | 1.7 | 0.5-5 |
| Emulsifier | 5.7 | 1-20 |
| Sweetner | 18.5 | 10-30 |
| Coffee | 1.3 | 0.8-5 |
| Protein Powder | 4.3 | 5-20 |
| Fiber | 4.3 | 5-20 |

### Example 8

Example 8 is a formulation for a frozen coffee custard hybrid product with low or zero dairy content. This formulation, known as the Express-O formula, is made in a fudge sickle-type formulation. The ingredients may include espresso coffee, gelatin, starch, guar gum, water, and small amounts of milk or cream. This formulation has no dairy or egg ingredients. These would be made for those enjoying the lower milk or cream versions of coffee without eggs while benefiting from additional protein, fat, and fiber.

| | Preferred Amount | Preferred Range |
|---|---|---|
| Ingredient | wt. % | wt. % |
| A - Water | 81.22 | 50-90 |
| B - Espresso Coffee | 2.23 | 1.5-5 |
| C - Corn Starch | 0.69 | 0.2-1 |
| D - Gelatin | 2.23 | 1-10 |
| E - Emulsifier | 0.93 | 0.5-2 |
| F - Sweetener | 12.67 | 5-20 |

The method for creating the above example comprises the following steps. For the first step, stir A—Water, B—Espresso Coffee, C—Corn Starch, D—Gelatin, and E—Emulsifier in a bowl, creating a mix. In the second step, heat the mix to 205 degrees F. until everything dissolves, about 30 minutes. In the third step, cool the mix down to 40 degrees F. The fifth step is to add F—Sweetener to the mix. In the sixth step, divide the mix into individual servings and insert a stick into each serving for handling, and then store the servings in the freezer.

### Example 9

Example 9 is a formulation for a frozen coffee custard hybrid product, but with a low dairy content. This formulation, known as the Macchiato formula, is made in a fudge sickle-type formulation. Additionally, this formulation has no egg ingredients. These would be made for those enjoying the health benefits of avoiding eggs.

| | Preferred Amount | Preferred Range |
|---|---|---|
| Ingredient | wt. % | wt. % |
| A - Water | 78.6 | 50-90 |
| B - Espresso Coffee | 2.16 | 1.5-5 |
| C - Corn Starch | 0.67 | 0.2-1 |
| D - Gelatin | 2.16 | 1-10 |
| E - Emulsifier | 0.9 | 0.5-2 |
| F - Sweetener | 12.27 | 5-20 |
| G - Milk | 3.23 | 2-6 |

The method for creating the above example comprises the following steps. For the first step, stir A—Water, B—Espresso Coffee, C—Corn Starch, D—Gelatin, and E—Emulsifier in a bowl, creating a mix. In the second step, heat the mix to 205 degrees F. until everything dissolves, about 30 minutes. In the third step, cool the mix down to 40 degrees F. The fifth step is to add F—Sweetener and G—Milk to the mix. In the sixth step, divide the mix into individual servings, insert a stick into each serving for easy handling, and then store the servings in the freezer.

### Example 10

Example 10 is a formulation for a frozen coffee custard hybrid product, but with a low dairy content. This formulation, known as the Cappuccino formula, is made in a fudge sickle-type formulation. As with Examples 7 and 8, this formulation has no egg ingredients. These would be made for those enjoying the health benefits of avoiding eggs.

| | Preferred Amount | Preferred Range |
|---|---|---|
| Ingredient | wt. % | wt. % |
| A - Water | 58.65 | 50-90 |
| B- Espresso Coffee | 1.61 | 1.5-5 |
| C- Corn Starch | 0.5 | 0.2-1 |
| D- Gelatin | 1.61 | 1-10 |
| E- Emulsifier | 0.67 | 0.5-2 |
| F- Sweetener | 9.15 | 5-20 |
| G - Milk | 7.32 | 2-6 |
| H - Whipped Cream | 20.45 | 15-30 |

The method for creating the above example comprises the following steps. For the first step, stir A—Water, B—Espresso Coffee, C—Corn Starch, D—Gelatin, and E—Emulsifier in a bowl, creating a mix. In the second step, heat the mix to 205 degrees F. until everything dissolves, about 30 minutes. In the third step, cool the mix down to 40 degrees F. The fifth step is to add F—Sweetener and G—Milk to the mix. In the sixth step fold the H—Whipped Cream into the mix. In the seventh step, divide the mix into individual servings, insert a stick into each serving for easy handling, and then store the servings in the freezer.

### Example 11

Example 11 is a formulation for a frozen coffee custard hybrid product. This formulation is known as the Caffe Latte formula.

| Ingredient | Amounts | |
|---|---|---|
| A - Egg Yolks | 12 | |
| B - Sweetener | 4 | Tbsp |
| C - Expresso Coffee (Freeze dry) | 5 | Tbsp |
| D - Fiber | 5 | Tbsp |
| E - Sea Salt | 1⅛ | Tsp |
| F - Vanilla | 2 | Tsp |
| G - Egg Whites | 12 | |
| H - Sweetener | 1 | Tbsp |
| I - Cream | 3 | Cups |
| J - Sweetener | 1 | Tbsp |

The method for creating the above example comprises the following steps. For the first step, place A—Egg Yolks and B—Sweetener in a bowl to create a first mix. For the second step, place the bowl over boiling water and whisk the first mix while heating to a range between 170 and 180 degrees F. The first mix will thicken and turn a light yellow. Hold the temperature for 10 minutes. For the third step, cool the first mix down to 40 degrees F. For the fourth step, add C—Expresso Coffee, D—Fiber, E—Sea Salt, F—Vanilla into the first mix. For the fifth step, place G—Egg Whites and H—Sweetener into a bowl to create a second mix. For the sixth step, whisk the second mix into soft peaks. For the seventh step, combine the second mix with the first mix to create a third mix. For the eighth step, add I—Cream and J—Sweetener and whisk into soft peaks to create a fourth mix. For the ninth step, add the fourth mix to the third mix to create a fifth mix. For the tenth step, pour the fifth mix into containers and freeze for 12 to 24 hours.

### Example 12

Example 12 is a formulation for a frozen coffee custard hybrid product. This formulation is known as the Decaf Caffe Latte formula.

| Ingredient | Amounts | |
|---|---|---|
| A - Egg Yolks | 12 | |
| B - Sweetener | 4 | Tbsp |
| C- Decaf Coffee (Freeze dry) | 5 | Tbsp |
| D - Fiber | 5 | Tbsp |
| E - Sea Salt | 1⅛ | Tsp |
| F - Vanilla | 2 | Tsp |
| G - Egg Whites | 12 | |
| H - Sweetener | 1 | Tbsp |
| I - Cream | 3 | Cups |
| J - Sweetener | 1 | Tbsp |

The method for creating the above example comprises the following steps. For the first step, place A—Egg Yolks and B—Sweetener in a bowl to create a first mix. For the second step, place the bowl over boiling water and whisk the first mix while heating to a range between 170 and 180 degrees F. The first mix will thicken and turn a light yellow. Hold the temperature for 10 minutes. For the third step, cool the first mix down to 40 degrees F. For the fourth step, add C—Decaf Coffee, D—Fiber, E—Sea Salt, F—Vanilla into the first mix. For the fifth step, place G—Egg Whites and H—Sweetener into a bowl to create a second mix. For the sixth step, whisk the second mix into soft peaks. For the seventh step, combine the second mix with the first mix to create a third mix. For the eighth step, add I—Cream and J—Sweetener and whisk into soft peaks to create a fourth mix. For the ninth step, add the fourth mix to the third mix to create a fifth mix. For the tenth step, pour the fifth mix into containers and freeze for 12 to 24 hours.

### Example 13

Example 13 is a formulation for a frozen coffee custard hybrid product. This formulation is known as the Coffee Mocha formula.

| Ingredient | Amounts | |
|---|---|---|
| A - Egg Yolks | 12 | |
| B - Sweetener | 4 | Tbsp |
| C- Expresso Coffee (Freeze dry) | 5 | Tbsp |
| D - Fiber | 5 | Tbsp |
| E- Cocoa Powder | 5 | Tbsp |
| F - Sea Salt | 1⅛ | Tsp |
| G - Vanilla | 2 | Tsp |
| H - Egg Whites | 12 | |
| I - Sweetener | 1 | Tbsp |
| J - Cream | 3 | Cups |
| K - Sweetener | 1 | Tbsp |

The method for creating the above example comprises the following steps. For the first step, place A—Egg Yolks and B—Sweetener in a bowl to create a first mix. For the second step, place the bowl over boiling water and whisk the first mix while heating to a range between 170 and 180 degrees F. The first mix will thicken and turn a light yellow. Hold the temperature for 10 minutes. For the third step, cool the first mix down to 40 degrees F. For the fourth step, add C—Expresso Coffee, D—Fiber, E—Cocoa Powder, F—Sea Salt, G—Vanilla into the first mix. For the fifth step, place H—Egg Whites and I—Sweetener into a bowl to create a second mix. For the sixth step, whisk the second mix into soft peaks. For the seventh step, combine the second mix with the first mix to create a third mix. For the eighth step, add J—Cream and K—Sweetener and whisk into soft peaks to create a fourth mix. For the ninth step, add the fourth mix to the third mix to create a fifth mix. For the tenth step, pour the fifth mix into containers and freeze for 12 to 24 hours.

### Example 14

Example 14 is a formulation for a frozen coffee custard hybrid product. This formulation is known as the Pumpkin Spice formula.

| Ingredient | Amounts | |
|---|---|---|
| A - Egg Yolks | 12 | |
| B - Sweetener | 4 | Tbsp |
| C- Expresso Coffee (Freeze dry) | 5 | Tbsp |
| D - Fiber | 5 | Tbsp |
| E- Pumpkin Puree | 5 | Tbsp |
| F - Sea Salt | 1⅛ | Tsp |
| G - Vanilla | 2 | Tsp |
| H - Pumpkin Spice | ¼ | Tsp |
| I - Egg Whites | 12 | |
| J - Sweetener | 1 | Tbsp |
| K - Cream | 3 | Cups |
| L - Sweetener | 1 | Tbsp |

The method for creating the above example comprises the following steps. For the first step, place A—Egg Yolks and B—Sweetener in a bowl to create a first mix. For the second step, place the bowl over boiling water and whisk the first mix while heating to a range between 170 and 180 degrees F. The first mix will thicken and turn a light yellow. Hold the temperature for 10 minutes. For the third step, cool the first mix down to 40 degrees F. For the fourth step, add C—Expresso Coffee, D—Fiber, E—Pumpkin Puree, F—Sea Salt, G—Vanilla, and H—Pumpkin Spice into the first mix. For the fifth step, place I—Egg Whites and J—Sweetener into a bowl to create a second mix. For the sixth step, whisk the second mix into soft peaks. For the seventh step, combine the second mix with the first mix to create a third mix. For the eighth step, add K—Cream and L—Sweetener and whisk into soft peaks to create a fourth mix. For the ninth step, add the fourth mix to the third mix to create a fifth mix. For the tenth step, pour the fifth mix into containers and freeze for 12 to 24 hours.

### Example 15

Example 15 is a formulation for a frozen coffee custard hybrid product. This formulation is known as the Frozen Mousse formula.

| Ingredient | Amounts | |
|---|---|---|
| A - Egg Yolks | 12 | |
| B - Sweetener | 4 | Tbsp |
| C- Expresso Coffee (Freeze dry) | 5 | Tbsp |
| D - Fiber | 5 | Tbsp |
| E - Sea Salt | 1⅛ | Tsp |
| F - Vanilla | 2 | Tsp |
| G - Egg Whites | 12 | |
| H - Sweetener | 1 | Tbsp |
| I - Cream | 3 | Cups |
| J - Sweetener | 1 | Tbsp |

The method for creating the above example comprises the following steps. For the first step, place A—Egg Yolks and B—Sweetener in a bowl to create a first mix. For the second step, place the bowl over boiling water and whisk the first mix while heating to a range between 170 and 180 degrees F. The first mix will thicken and turn a light yellow. Hold the temperature for 10 minutes. For the third step, cool the first mix down to 40 degrees F. For the fourth step, add C—Expresso Coffee, D—Fiber, E—Sea Salt, and F—Vanilla into the first mix. For the fifth step, place G—Egg Whites and H—Sweetener into a bowl to create a second mix. For the sixth step, whisk the second mix into soft peaks. For the seventh step, add the second mix to the first mix, creating a third mix. For the eighth step, add I—Cream and J—Sweetener and whisk into soft peaks to create a fourth mix. For the ninth step, add the fourth mix to the third mix to create a fifth mix. For the tenth step, pour the fifth mix into containers and freeze for 12 to 24 hours.

### Example 16

Example 16 is a formulation for a frozen coffee custard hybrid product. This formulation is known as the Semi-freddo formula.

| Ingredient | Amounts | |
|---|---|---|
| A - Egg Yolks | 12 | |
| B - Sweetener | 5 | Tbsp |
| C- Expresso Coffee (Freeze dry) | 5 | Tbsp |
| D - Fiber | 5 | Tbsp |
| E - Sea Salt | 1⅛ | Tsp |
| F - Vanilla | 2 | Tsp |
| G - Cream | 3 | Cups |
| H - Sweetener | 1 | Tbsp |

The method for creating the above example comprises the following steps. For the first step, place A—Egg Yolks and B—Sweetener in a bowl to create a first mix. For the second step, place the bowl over boiling water and whisk the first mix while heating to a range between 170 and 180 degrees F. The first mix will thicken and turn a light yellow. Hold the temperature for 10 minutes. For the third step, cool the first mix down to 40 degrees F. For the fourth step, add C—Expresso Coffee, D—Fiber, E—Sea Salt, and F—Vanilla into the first mix. For the fifth step, place G—Cream and H—Sweetener into a bowl to create a second mix. For the sixth step, whisk the second mix into soft peaks. For the seventh step, add the second mix to the first mix to create a third mix. For the eight step, pour the third mix into containers and freeze for 12 to 24 hours.

### Example 17

Example 17 is a formulation for a frozen coffee custard hybrid product. This formulation is known as the Frozen Coffee Yogurt formula.

| Ingredient | Amounts | |
|---|---|---|
| A - Expresso Coffee (Freeze dry) | 2 | Tbsp |
| B - Milk | ½ | Cup |
| C- Water | ¼ | Cup |
| D - Sugar | ⅔ | Cup |
| E - Egg Whites | 2 | |
| F - Greek Yogurt (Plain and Cold) | 2 | Cups |
| G - Vanilla | 1 | Tbsp |

The method for creating the above example comprises the following steps. For the first step, bring B—Milk to a simmer. For the second step, add A—Coffee to the milk to create a first mix. Stir and set aside. For the third step, combine C—Water and D—Sugar and bring to a boil, without stirring, over medium-high heat to create a second mix. When the second mix comes to a full boil, continue to boil for 1 minute. While the second mix boils, beat E—Egg Whites to soft peaks as a third mix. For the fourth step, continue beating the third mix on low speed and very slowly stream in the second mix. When all the second mix has been incorporated, turn the mixer to high and beat until the meringue is glossy and has cooled almost to room temperature for 2 to 3 minutes. This will create a fourth mix. For the fifth step, whisk together F—Greek Yogurt and G—Vanilla with the first mix until smooth, and then fold it into the fourth mix to create a fifth mix. For the sixth step, pour the fifth mix into an ice cream maker and freeze. For the seventh step, transfer the fifth mix to a freezer-safe container and chill in the freezer for 2 to 3 hours to allow the mixture to set completely.

### Example 18

Example 18 is a formulation for a frozen coffee custard hybrid product. This formulation is known as the Coffee Ice Cream with No Eggs formula.

| Ingredient | Amounts | |
|---|---|---|
| A - Expresso Coffee (Freeze dry) | 2 | Tbsp |
| B - Milk | 1 | Cup |
| C- Cream | 2 | Cups |
| D - Sugar | ⅔ | Cup |
| E - Salt | Dash | |
| F - Vanilla | 1 | Tbsp |

The method for creating the above example comprises the following steps. For the first step, dilute A—Coffee with B—Milk to create a first mix. For the second step, whisk into the first mix, C—Cream, D—Sugar, E—Salt, and F—Vanilla to create a second mix. For the third step, refrigerate the second mix for 30 minutes or longer. For the fourth step, pour the second mix into an ice cream maker as directed. Churn ice cream as directed in your ice cream maker's manual. This typically takes 30-40 minutes. For the fifth step, optional for a harder ice cream, transfer the second mix into a freezer for 6 to 8 hours or overnight.

### Example 19

Example 19 is a formulation for a frozen coffee custard hybrid product. This formulation is known as the Coffee and KETO Donut formula, which includes a coating of a breakfast or pastry food product. This allows the individual consuming the product to have a complete breakfast, which consists of the breakfast or pastry food product, along with coffee and dairy. This product may also be made in sandwich form. Breakfast and pastry food products can include, but are not limited to, bacon and crumbled bagels, granola, pastries such as donuts, cookies, sugar-free apple jam/keto-pie crust, brownies, or other ingredients made in keto or sugar-free forms. This is a genuinely unique, one-handed breakfast.

| Ingredient | Amounts | |
|---|---|---|
| A - Egg Yolks | 12 | |
| B - Sweetener | 4 | Tbsp |
| C- Coffee | 5 | Tbsp |
| D - Fiber | 5 | Tbsp |
| E - Salt | 1⅛ | Tsp |
| F - Vanilla | 2 | Tsp |
| G - Egg Whites | 12 | |
| H - Sweetener | 1 | Tbsp |
| I - Cream | 3 | Cups |
| J - Sweetener | 1 | Tbsp |

The method for creating the above example comprises the following steps. For the first step, place A—Egg Yolks and B—Sweetener in a bowl to create a first mix. For the second step, place the bowl over boiling water and whisk the first mix while heating to a range between 170 and 180 degrees F. The first mix will thicken and turn a light yellow. Hold the temperature for 10 minutes. For the third step, cool the first mix down to 40 degrees F. For the fourth step, add C—Coffee, D—Fiber, E—Sea Salt, and F—Vanilla into the first mix. For the fifth step, place G—Egg Whites and H—Sweetener into a bowl to create a second mix. For the sixth step, whisk the second mix into soft peaks. For the seventh step, combine the second mix with the first mix to create a third mix. For the eighth step, pour the third mix into ice cream bar molds and chill in the freezer for one hour. For the ninth step, place a stick in the center of the bars and continue freezing for 12 to 24 hours. For the tenth step, dip a bar into warm salt water for 5 seconds. Place the bar on donut crumbs and freeze again for one hour.

### Example 20

Example 20 is a formulation for a frozen coffee custard hybrid product. This formulation is known as the Cafe Late-Scout formula. This formula adds an additional step to freeze-dry the product and may be applied to many of the examples above.

| Ingredient | Amounts | |
|---|---|---|
| A - Egg Yolks | 12 | |
| B - Sweetener | 4 | Tbsp |
| C- Coffee | 5 | Tbsp |
| D - Fiber | 5 | Tbsp |
| E - Salt | 1⅛ | Tsp |
| F - Vanilla | 2 | Tsp |
| G - Egg Whites | 12 | |
| H - Sweetener | 1 | Tbsp |
| I - Cream | 3 | Cups |
| J - Sweetener | 1 | Tbsp |

The method for creating the above example comprises the following steps. For the first step, place A—Egg Yolks and B—Sweetener in a bowl to create a first mix. For the second step, place the bowl over boiling water and whisk the first mix while heating to a range between 170 and 180 degrees F. The first mix will thicken and turn a light yellow. Hold the temperature for 10 minutes. For the third step, cool the first mix down to 40 degrees F. For the fourth step, add C—Coffee, D—Fiber, E—Sea Salt, and F—Vanilla into the first mix. For the fifth step, place G—Egg Whites and H—Sweetener into a bowl to create a second mix. For the sixth step, whisk the second mix into soft peaks. For the seventh step, combine the second mix with the first mix to create a third mix. For the eighth step, pour the third mix into ice cream bar molds and chill in the freezer for one hour. For the ninth step, place a stick in the center of the bars and continue freezing for 12 to 24 hours. For the tenth step, dip a bar into warm salt water for 5 seconds. Place the bar on donut crumbs and freeze again for one hour. For the eleventh step, transfer the bars into a freeze dryer and set the temperature to 40 degrees F. and full vacuum until dry, typically 24 to 60 hours.

The resulting product has a 25-year shelf life and can be used by athletes, campers, outdoorsmen, pilots, military (Army, Navy, Marines, and Air Force), and anyone in space or any profession that wants portable extended shelf-life coffee products.

Other forms of the frozen coffee custard product may be derived by those skilled in the art. For example, the disclosed frozen coffee custard product may incorporate cake layers, allowing consumers to enjoy a cake dessert alongside coffee in a single product. Another form of the frozen coffee custard product can be achieved by freeze-drying the product and then cryogrinding the bar into a fine powder. Consumers could then add an amount to a cup of hot water and instantly enjoy any of the espresso drinks in the examples above.

What is claimed is:

1. A coffee custard hybrid product formulation comprising:
a) from about 25 to about 75 wt. % of milk;
b) from about 5 to about 20 wt. % of cream;
c) from about 0.5 to about 5 wt. % skim powder;
d) from about 1 to about 20 wt. % emulsifier;
e) from about 10 to about 30 wt. % sweetener;
f) from about 0.8 to about 5 wt. % coffee; and
g) served frozen.

2. The formulation of claim 1 wherein the coffee is decaffeinated.

3. The formulation of claim 1 further comprising:
a) from about 10 to about 20 wt. % caramel and
b) from about 0.2 to about 1.0 wt. % cinnamon.

4. The formulation of claim 1 further comprising cocoa from about 0.2 to about 1.0 wt. %.

5. The formulation of claim 1 further comprising almond extract from about 0.05 to about 0.20 wt. %.

6. The formulation of claim 1 further comprising:
a) from about 5 to about 20 wt. % pumpkin puree and
b) from about 0.2 to about 1.0 wt. % pumpkin spice.

7. The formulation of claim 1 further comprising:
a) from about 5 to about 20 wt. % protein powder and
b) from about 5 to about 20 wt. % fiber.

8. A coffee custard hybrid product formulation comprising:
a) from about 50 to about 90 wt. % of water;
b) from about 1.5 to about 5 wt. % of espresso coffee;
c) from about 0.2 to about 1 wt. % corn starch;
d) from about 1 to about 10 wt. % gelatin;
e) from about 0.5 to about 2 wt. % emulsifier;
f) from about 5 to about 20 wt. % sweetener; and
g) served frozen.

9. The formulation of claim 8 further comprising milk from about 2 to about 6 wt. %.

10. The formulation of claim 8 further comprising:
c) from about 2 to about 6 wt. % milk and
d) from about 15 to about 30 wt. % whipped cream.
